(19) United States
(12) Patent Application Publication
(10) Pub. No.: US 2009/0064318 A1
(43) Pub. Date: Mar. 5, 2009

(54) METHOD OF INPUTTING BOOTING PASSWORD

(75) Inventor: Jia-Shiung GUO, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Corporation, Taipei City (TW)

(21) Appl. No.: 11/845,368

(22) Filed: Aug. 27, 2007

(51) Int. Cl. G06F 7/04

(52) U.S. Cl. 726/19

(57) ABSTRACT

A method of inputting a booting password includes the following steps. When a computer is powered on, firstly, a first password input screen is outputted, which waits for a first password to be inputted. Next, if a second password input activating signal is received during the waiting process, a second password input screen is outputted, which waits for a second password to be inputted. Then, after the input of the first password or the second password is finished, an operating system is booted.

### BACKGROUND OF THE INVENTION

1. Field of the Invention

The present invention relates to a method of inputting a booting password. More particularly, the present invention relates to a method of inputting a booting password, which is capable of switching to a second password input screen once a second password input activating signal is received during a first password input screen.

2. Related Art

Notebook computer is a kind of portable computers, and the current developing trend is that the weight becomes increasingly light, and the function becomes increasingly strong. In order to follow the developing trend, the notebook computer has switched from business computers originally suitable for word processing to entertainment computers capable of processing multimedia. Recently, the business function mainly lies in briefing, and the entertainment function mainly lies in playing the multimedia. However, when using the computer as the above two functions, a user is usually reached a bit far from the notebook computer. In order to prevent the user from continuously moving to the front of the notebook computer, some manufacturers develop a remote controller for the purposes of briefing and playing the multimedia, such that the user can give the briefing or play the multimedia files, without staying in front of the notebook computer.

Recently, most remote controllers disposed for the notebook computer transmit the signal to the notebook computer through infrared rays, and depending upon different operating functions for the remote controller, scores of keys are disposed on the remote controller at the utmost. When the user operates the remote controller 120 disposed for the notebook computer 110, it is easy to use the remote controller 120 as using a common remote controller (e.g., a remote controller of a TV set). As shown in FIG. 1, after the user presses the key representing each function on the remote controller 120, the remote controller 120 transmits a signal corresponding to the key to a receiver of the notebook computer 110. Then, the program executed in the notebook computer 110 converts the signal to a corresponding command, such that the user can start a multimedia playing program, such as a video and audio playing program or a music playing program, and can control to play, pause, or fast forward the film or the music. The remote controller 120 can also scroll the window of the browsed web page in the browser, switch the projection sheets displayed by the briefing software, even control the optical disc drive to play the CD, and directly power on or off the notebook computer. The above-mentioned items can be operated through the remote controller.

Although the remote controller disposed for the notebook computer can enable the user to power on and off the notebook computer and play the multimedia files at a certain distance away, without touching the notebook computer, many user usually set a booting password in Basic Input Output System (BIOS) on the notebook computer, such that the user must input the password during the booting operation of the notebook computer.

### SUMMARY OF THE INVENTION

In view of the problem that the user must touch a notebook computer to input a password when using a remote controller to boot the notebook computer, the present invention is directed to a method of inputting a booting password. When a first password input screen is outputted, if a second password activating signal is received, a second password input screen is outputted, such that the user can switch different input devices (e.g., a keyboard and a remote controller) to input the password for booting. In this manner, the password can be inputted without touching the computer, and thus, the problems of the prior art can be solved.

In order to achieve the above objective, the method provided by the present invention includes the following steps: firstly, performing a power on self test (POST) procedure, and outputting a first password input screen; next, determining whether a second password input activating signal is received or not; then, outputting a second password input screen, if the second password input activating signal is received; receiving a second password, and booting an operating system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic view of a conventional notebook computer remote-controlled by a corresponding remote controller;

FIG. 2 is a flow chart of a method of inputting a booting password according to the present invention;

FIG. 3A is a schematic view of a BIOS setting screen for setting a remote controller password according to an embodiment of the present invention; and

FIG. 3B is a schematic view of the BIOS setting screen for setting the remote controller password according to an embodiment of the present invention.

### DETAILED DESCRIPTION OF THE INVENTION

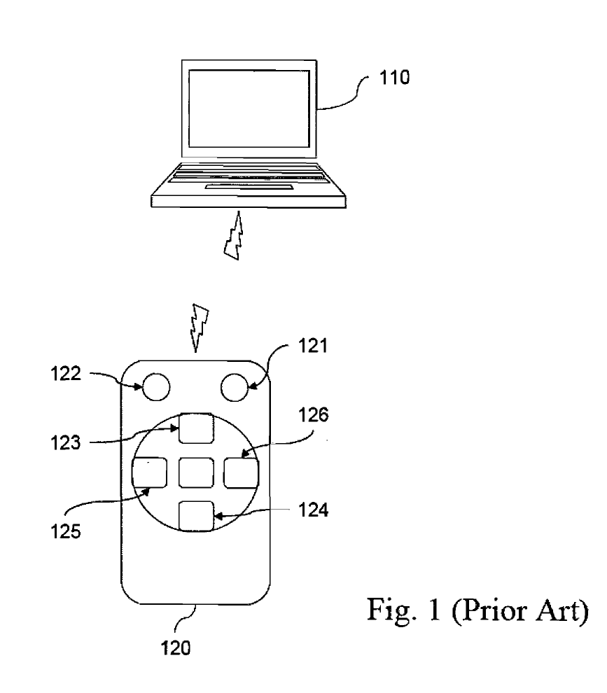

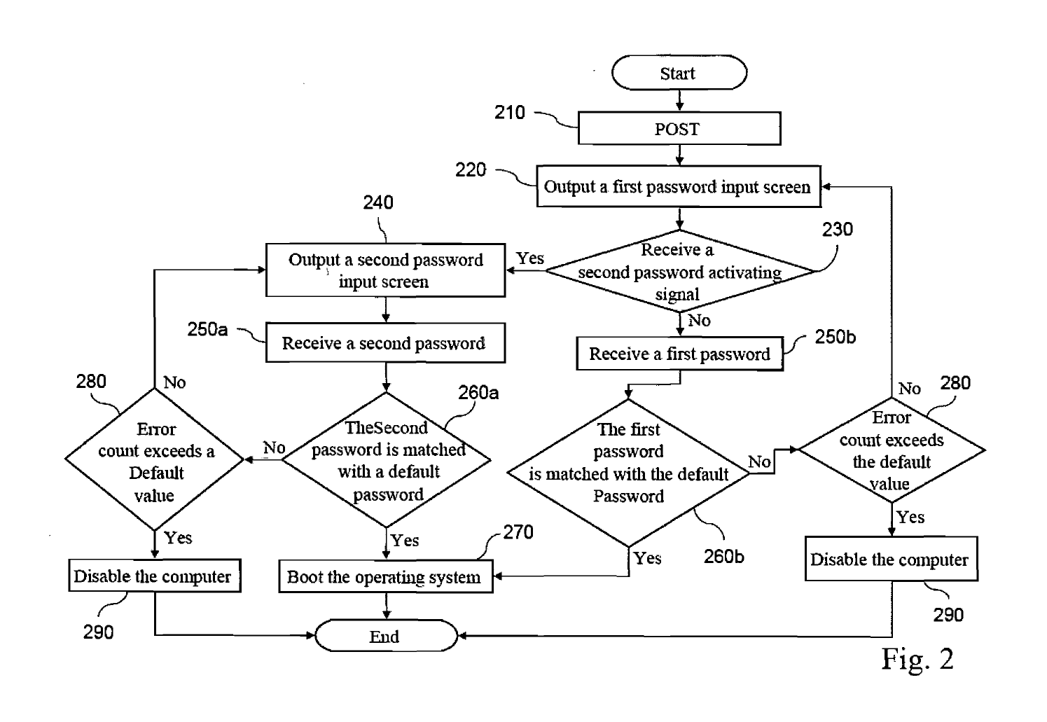

The operating manner of the present invention is illustrated below through a first embodiment of the present invention. Referring to FIG. 2, it is a flow chart of a method of inputting a booting password according to the present invention. The remote controller provided by the present invention is not limited to the remote controller shown in FIG. 1. In this embodiment, the present invention is applied on the notebook computer, but not limited to being applied on the notebook computer, and the present invention can be used on any other computer that is required to input the password after being powered on. The first password and the second password provided by the present invention can be selectively inputted through different input devices, for example, if the first password is inputted by using the keyboard, the second password is inputted by using the remote controller, which is taken as an example in this embodiment, but the present invention it is not limited to use the keyboard and the remote controller as the input devices to input the first password and the second password, and using the keyboard together with any other input device such as a mouse to input the first password and the second password respectively also falls in the scope of the present invention.

When the user intends to use a notebook computer 110, the user presses an ON/OFF key 121 on a remote controller 120 corresponding to the notebook computer 110, the remote controller 120 transmits an booting signal to the notebook computer 110, and once a receiver in the notebook computer 110 receives the booting signal, the notebook computer 110 is booted, such that the BIOS begins performing the booting operation.

During the process of performing the booting operation by the BIOS, the notebook computer 110 must perform a POST procedure (Step 210). In the POST procedure, the BIOS initializes relevant information of the receiver (e.g., a remote controller signal receiver, a keyboard receiver, or a mouse receiver) in the computer, such that the program executed in the notebook computer 110 can obtain the data in the receiver by generating interrupts. If the user sets that a password must be inputted so as to boot the computer, the present invention outputs a first password input screen to prompt the user to input a first password (Step 220). In this embodiment, the first password is the BIOS password inputted conventionally through the keyboard, and during the booting operation, the user can press a specific key to enter the setting menu of the BIOS to add the first password into a predetermined password group.

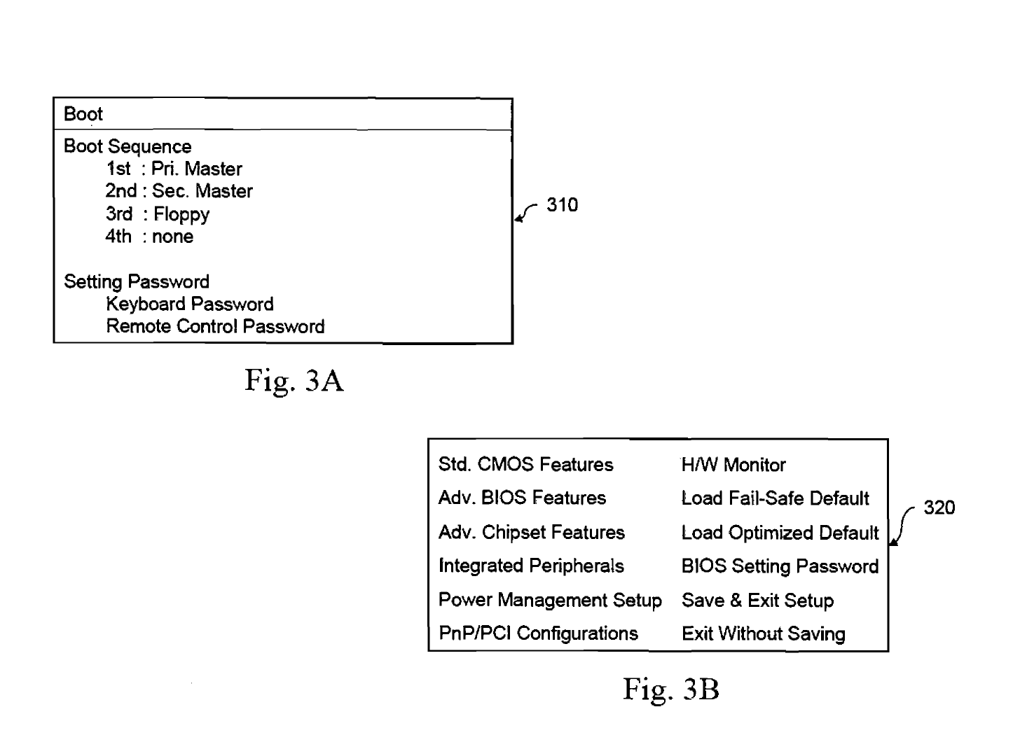

In this embodiment, the first password is inputted through the keyboard, so the process of adding the first password to the predetermined password group is the same as the conventional process of setting the BIOS password. In the conventional BIOS setting screen 310 as shown in FIG. 3A, an option of “Keyboard Password” is selected, and the setting process is not described in detail herein. If the first password is not inputted through the keyboard, but through a specific input device, such as the remote controller or the mouse, the user can also select an option of setting the first booting password in the BIOS setting menu to add the first password to the predetermined password group, for example, an option of “Remote Controller Password” as shown in FIG. 3A indicates that the remote controller can be used to input the first password to add the first password to the predetermined password group. If any other input device is used, the first password is added to the predetermined password group, after the corresponding input option is selected and the first password is inputted.

When the user saw the first password input screen output by the present invention (Step 220), he/she may press a switching key 122 on the remote controller 120 to make the remote controller 120 transmit a second password activating signal to the notebook computer 110. After the receiver in the notebook computer 110 receives the second password activating signal sent from the remote controller 120 (Step 230), the second password activating signal is transferred to the BIOS, so the BIOS generates and outputs a second password input screen (Step 240). In this embodiment, the remote controller 120 is used to input the second password, so the user can also select the option of the second password in the BIOS setting menu to input the second password and to add the second password to the predetermined password group, for example, the option of “Remote controller Password” as shown in FIG. 3A, or the option of “BIOS Setting Password” in the conventional BIOS setting screen 320 is selected as shown in FIG. 3B, and the second password is added in the predetermined password group through the setting flow shown in FIG. 4. The present invention can firstly prompt the user to input the first password, and after the user inputs the first password, the present invention can prompt the user to input the second password. In this embodiment, for example, the user presses an up key 123, a down key 124, a left key 125, and a right key 126 in sequence. When the user presses the four keys of the up, down, left, and right keys in the present invention, the receiver receives that the four keys of the up, down, left, and right keys are pressed by the user, and signals corresponding to the up, down, left, and right keys are added to the predetermined password group, so as to finish the action of setting the second booting password.

After the user saw a prompt message of inputting the second password of the present invention (Step 240), the user presses the four keys of the up, down, left, and right keys at this time. The second password represented by the four keys of the up, down, left, and right key signals is sent to the receiver in the notebook computer 110 by the remote controller 120. After the present invention receives signals corresponding to the four keys of the up, down, left, and right key that represent the second password transferred by the receiver (Step 250a). The second password is compared with each password in the predetermined password group (Step 260a). If the second password is the same as one group of passwords in the predetermined password group, so the step of booting the operating system is entered (Step 270). In this manner, it is not necessary for the user to use the keyboard to input the first password in front of the notebook computer 110, and thus, the present invention can solve the problem of the conventional art.

If the key signal inputted by the user and received by the present invention is “up, up, down, left, and right” (Step 250a), when the second password is compared with each password in the predetermined password group (Step 260a), it is found that the predetermined password group does not have a password matched with the second password. Therefore, the present invention outputs the second password input screen to prompt the user to input the second password again (Step 240). The same steps are continuously repeated till the user inputs the correct second password. Practically, in order to prevent the user from continuously guessing the correct password, when the second password inputted by the user does not exist in the predetermined password group, the present invention calculates an error count. If the error count of inputting the second password by the user exceeds a predetermined value (e.g., three) (Step 280), the present invention disables the notebook computer 110 by means of powering off the computer (Step 290).

In addition, when the present invention outputs the first password input screen (Step 220) to prompt the user to input the first password, if the user does not use the remote controller to input the second password activating signal but uses the keyboard to input the first password. And then, after the present invention receives the first password (Step 250b), it is determined whether the first password is matched with any password in the predetermined password group (Step 260b). If yes, the operating system is booted (Step 270); and if no, the first password input screen is outputted (Step 220) to continuously prompt the user to input the first password. Similarly, in order to prevent the user from continuously guessing the correct password, when the first password inputted by the user does not exist in the predetermined password group, the present invention calculates an error count. If the error count of inputting the first password by the user exceeds a predetermined value (Step 280), the present invention disables the notebook computer 110 by powering off the computer (Step 290).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of inputting a booting password, used in booting of a computer that is controlled by a remote controller and a keyboard, comprising:
performing a power on self test (POST) procedure, and outputting a first password input screen;
determining whether a second password input activating signal is received;
outputting a second password input screen, if the second password input activating signal is received; and
receiving a second password, and booting an operating system.

2. The method of inputting the booting password as claimed in claim 1, wherein the step of receiving the second password and booting the operating system comprises:
receiving the second password;
determining whether the second password is matched with one of a predetermined password group or not; and
booting the operating system, if it is determined that the second password is matched with one of the predetermined password group.

3. The method of inputting the booting password as claimed in claim 2, wherein the step of receiving the second password and booting the operating system further comprises:
determining whether a count for receiving the second password exceeds a predetermined value or not, if the second password is not matched with the predetermined password group;
outputting the second password input screen again, if the count for receiving the second password does not exceed the predetermined value; and
stopping the POST procedure and disabling the computer, if the count for receiving the second password exceeds the predetermined value.

4. The method of inputting the booting password as claimed in claim 1, further comprising:
maintaining to output the first password input screen, if the second password input activating signal is not received;
receiving a first password;
determining whether the first password is matched with one of a predetermined password group or not; and
booting the operating system, if the first password is matched with one of the predetermined password group.

5. The method of inputting the booting password as claimed in claim 4, further comprising:
determining whether a count for receiving the first password exceeds a predetermined value or not, if the first password is not matched with the predetermined password group;
outputting the first password input screen again, if the count for receiving the first password does not exceed the predetermined value; and
stopping the POST procedure and disabling the computer, if the count for receiving the first password exceeds the predetermined value.

6. The method of inputting the booting password as claimed in claim 4, wherein the first password is inputted through the keyboard.

7. The method of inputting the booting password as claimed in claim 4, wherein the first password is inputted through the remote controller.

8. The method of inputting the booting password as claimed in claim 1, wherein the step of performing the POST procedure and outputting the first password input screen comprises:
determining whether a predetermined password group is built in or not;
outputting the first password input screen, if the predetermined password group is built in;
booting the operating system, if the predetermined password group is not built in.

9. The method of inputting the booting password as claimed in claim 1, wherein the second password is inputted through the keyboard.

10. The method of inputting the booting password as claimed in claim 1, wherein the second password is inputted through the remote controller.
